(19) United States
(12) Patent Application Publication
(10) Pub. No.: US 2026/0267144 A1
(43) Pub. Date: Sep. 10, 2026

(54) PASSIVE WORLD-REFERENCED DISPLAY ALIGNMENT WITH REFLECTIVE FACET LIGHTGUIDES

(71) Applicant: GOOGLE LLC, Mountain View, CA (US)

(72) Inventor: Daniel Adema, Kitchener (CA)

(21) Appl. No.: 18/873,675

(22) PCT Filed: May 9, 2023
(86) PCT No.: PCT/US2023/021548

§ 371 Date: Dec. 10, 2024

Related U.S. Application Data
(60) Provisional application No. 63/357,140, filed on Jun. 30, 2022.

(51) Int. Cl. G02B 27/01; G02B 5/12; G02B 27/28

(52) U.S. Cl. CPC G02B 27/0172; G02B 5/12; G02B 27/283; G02B 2027/0178

(57) ABSTRACT

A head-worn display (HWD) is configured to maintain the angle at which light leaves an outcoupler even as the HWD moves. To this end, the HWD includes an optical engine configured to emit display light. Additionally, the HWD includes a lightguide that has an incoupler and an outcoupler. The incoupler is configured to reflect the display light emitted from the optical engine such that the display light propagates through the lightguide by performing an even number of bounces before being received by the outcoupler. The outcoupler then provides the display light to the eye of a user.

### BACKGROUND

In some head-wearable displays (HWD), images are displayed to a user by coupling light beams from a projector into an incoupler of a lightguide. The incoupler then provides the light beams to a main body of the lightguide within which the light beams propagate by total internal reflection (TIR). The light beams propagate through the lightguide until they are received at an outcoupler of the lightguide configured to direct the light beams out of the lightguide and toward the user. The light beams directed out of the lightguide toward the eye of the user overlap at a distance away from the lightguide forming an exit pupil within which a virtual image is generated that can be viewed by the user. However, within some HWDs, movement by the user causes the lightguide to shift or rotate. For such HWDS, as the lightguide shifts or rotates, the angle at which light is directed out of the lightguide changes, increasing the likelihood that the exit pupil is not formed as intended and negatively impacting the virtual image presented to the user.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a diagram of an example display system housing a projector system configured to project images toward the eye of a user, in accordance with some embodiments.

FIG. 2 is a diagram of a projection system that projects images directly onto the eye of a user via display light, in accordance with some embodiments.

FIG. 3 is a diagram of a projection system including one or more reflective facets configured to provide light to the eye of a user, in accordance with some embodiments.

FIG. 4 is a diagram of a projection system including a retroreflector and one or more reflective facets configured to provide light to the eye of a user, in accordance with some embodiments.

FIG. 5 is a diagram of a projection system including a retroreflector and a quarter wave plate configured to provide light to the eye of a user, in accordance with some embodiments.

FIGS. 6 and 7 together show display light propagating through a lightguide with an odd number of bounces when the lightguide is at a first position and a second position, in accordance with embodiments.

FIGS. 8 and 9 together show display light propagating through a lightguide with an even number of bounces when the lightguide is at a first position and a second position, in accordance with embodiments.

FIG. 10 is a diagram of a lightguide having an extended shape and one or more reflective facets configured to provide light to the eye of a user, in accordance with some embodiments.

FIG. 11 is a diagram illustrating a partially transparent view of a head-worn display (HWD) that includes a projection system, in accordance with some embodiments.

### SUMMARY OF EMBODIMENTS

Techniques and systems described herein are directed to a lightguide configured to maintain the angle at which an outcoupler directs light out of the lightguide as the lightguide rotates. According to an example embodiment, a head-worn display (HWD) includes an optical engine configured to emit display light. Further, the HWD can include a lightguide having an incoupler and an outcoupler. The incoupler can be configured to reflect the display light such that the display light propagates through the lightguide by performing an even number of bounces before being received by the outcoupler.

In embodiments, the outcoupler may be configured to direct the display light out of the lightguide at a first angle when the lightguide is at a first angle. Further, the outcoupler can be configured to direct the display light out of the lightguide at the first angle when the lightguide is at a second angle different from the first angle. Additionally, in embodiments, the incoupler can include one or more reflective facets configured to reflect the display light into the lightguide. Also, the HWD can include a retroreflector configured to reflect the display light emitted from the optical engine toward the incoupler. Further, the HWD can include a quarter waveplate disposed between the lightguide and the retroreflector. According to embodiments, the incoupler may include a polarizing beam splitter (PBS) configured to provide display light polarized in a first linear direction to the quarter waveplate. The quarter waveplate can be configured to polarize the display light reflected off the retroreflector to produce display light polarized in a second linear direction perpendicular to the first linear direction. Also, the PBS may be configured to reflect the display light polarized in the second linear direction into the lightguide.

Further, in some embodiments, the lightguide can have a first thickness at a first end of the lightguide and a second thickness at a second, opposite end of the lightguide, wherein the first thickness is different from the second thickness.

Additionally, the outcoupler can include one or more reflective facets configured to reflect the display light out of the lightguide 205. Also, the HWD may include the shape of an eyeglasses frame.

In another example embodiments, a lightguide for a HWD includes an outcoupler having one or more reflective facets. Additionally, the lightguide can include an incoupler having one or more reflective facets. The reflective facets of the incoupler can be configured to reflect display light such that the display light propagates through the lightguide by performing an even number of bounces before being received by the outcoupler.

According to embodiments, the outcoupler may be configured to direct the display light out of the lightguide at a first angle when the lightguide is at a first angle. Further, the outcoupler can be configured to direct the display light out of the lightguide at the first angle when the lightguide is at a second angle different from the first angle. As well, the lightguide can include a retroreflector disposed on a surface of the lightguide and configured to reflect the display light toward the incoupler.

The lightguide may also include a first thickness at a first end of the lightguide and a second thickness at a second, opposite end of the lightguide, wherein the first thickness is different from the second thickness. Additionally, the one or more reflective facets of the outcoupler can be disposed within the lightguide. Further, the one or more reflective facets of the incoupler may be disposed within the lightguide.

As another example, a method includes reflecting, by an incoupler of a lightguide, display light into the lightguide such that the display light propagates through the lightguide by performing an even number of bounces before being received at an outcoupler of the lightguide. Further, the method can include directing, by the outcoupler of the lightguide, the display light out of the lightguide at an angle.

In embodiments, the method may also include maintaining the angle that the display light is directed out of the lightguide as the lightguide rotates. Within the method, the outcoupler can include one or more reflective facets configured to reflect the display light out of the lightguide. Additionally, the method can include reflecting, by a retroreflector, the display light toward the incoupler of the lightguide. Also, the method can include providing a portion of the display light polarized in a first linear direction to a quarter waveplate. The method may further include polarizing the portion of the display light polarized in the first linear direction in a circular direction to produce circularly polarized display light. The method can also include polarizing the circularly polarized display light to produce display light polarized in a second linear direction perpendicular to the first linear direction. Within the method, reflecting the display light into the lightguide can include reflecting the display light polarized in the second linear direction into the lightguide.

### DETAILED DESCRIPTION

Some head-worn displays (HWDs) (e.g., augmented reality head-worn displays) are designed to look like eyeglasses, with at least one of the lenses containing a lightguide to direct light to a user's eye. The combination of the lens and lightguide is referred to as an “optical combiner,” “optical combiner lens,” or both. Such lightguides form, for example, exit pupil expanders (EPEs) and outcouplers that form and guide light to the user's eye. The HWDs generally have a frame designed to be worn in front of a user's eyes to allow the user to view both their environment and computer-generated content projected from the combiner. Components that are necessary to the functioning of a typical HWDs, such as, for example, an optical engine to project computer-generated content (e.g., display light representative of one or more images), cameras to pinpoint physical location, cameras to track the movement of the user's eye(s), processors to power the optical engine, and a power supply, are typically housed within the frame of the HWD. As an HWD frame has limited volume in which to accommodate these components, it is desirable that these components be as small as possible and configured to interact with the other components in very small volumes of space.

To guide light to a user's eye, some HWDs include an optical engine configured to emit display light (e.g., laser light, white light, red light, blue light, green light) representing an image toward an incoupler of a lightguide. Such an incoupler, for example, includes one or more reflective facets (e.g., structures configured to reflect light) that provide the received light to a main body of the lightguide. The light then propagates through the lightguide using total internal reflection (TIR), partial internal reflection (PIR), or both until the light is received at an outcoupler of the lightguide. The outcoupler, for example, includes one or more reflective facets (e.g., structures configured to reflect light) that direct the light out of the lightguide and toward the eye of the user. As the light is directed out of the lightguide, the light forms an exit pupil a distance away from the lightguide that includes the image included in the emitted light. Further, the light forms the exit pupil at or near the pupil of the eye of the user so the image in the exit pupil is visible to the user. However, as the head of the user moves or rotates, the lightguide within the HWD also moves or rotates, changing the angle at which the light exits the lightguide. Because the angle of the light exiting the lightguide changes, the position of the exit pupil is changed, negatively impacting user experience. For example, changing the angle at which light exits the lightguide increases the likelihood that the exit pupil forms at a position away from the eye of the user such that the image in the exit pupil is not visible to the user, negatively impacting user experience.

To this end, techniques and system disclosed herein as directed to providing a lightguide that maintains the angle at which light exits the lightguide even when the lightguide moves or rotates. For example, a lightguide includes an incoupler having one or more reflective facets configured to reflect received light such that the light propagates through the lightguide using TIR. Such reflective facets, for example, include one or more structures disposed within a lightguide having one or more reflective surfaces, reflective coatings, mirrors (e.g., di-electric mirrors, metallic mirrors, Bragg facets), mirror coatings, or any combination thereof. Further, the lightguide includes an outcoupler having one or more reflective facets (e.g., one or more structures disposed within a lightguide having one or more reflective surfaces, reflective coatings, mirrors, mirror coatings, or any combination thereof) configured to reflect light such that the light is directed out of the light guide and toward the eye of a user.

In response to receiving light representing an image emitted from an optical engine, the incoupler of the lightguide is configured to reflect at least a portion of the received light such that the portion of the received light propagates through the lightguide using TIR before being received at an outcoupler of the lightguide. While propagating through the lightguide using TIR, the received light reflects off the surfaces of the lightguide until the light is received at the outcoupler. Herein, each reflection of the received light off a surface of the lightguide as the received light propagates via TIR is referred to as a “bounce.” To help maintain the angle at which the outcoupler directs light out of the lightguide even when the lightguide moves or rotates, the incoupler reflects received light such that the received has an even number of bounces as it propagates through the lightguide via TIR before being received by the outcoupler. That is to say, the received light reflects off the surfaces of the lightguide an even number of times before being received at the outcoupler. After receiving the received light, the outcoupler directs the received light out of the lightguide at an angle. Because the incoupler reflects received light such that the received has an even number of bounces as it propagates through the lightguide, the angle at which the outcoupler directs the received light out of the lightguide is maintained even when the lightguide moves or rotates. As such, the position of the exit pupil formed by the light exiting the lightguide is maintained, allowing the user to see an image even when the lightguide moves or is rotated and improving user experience.

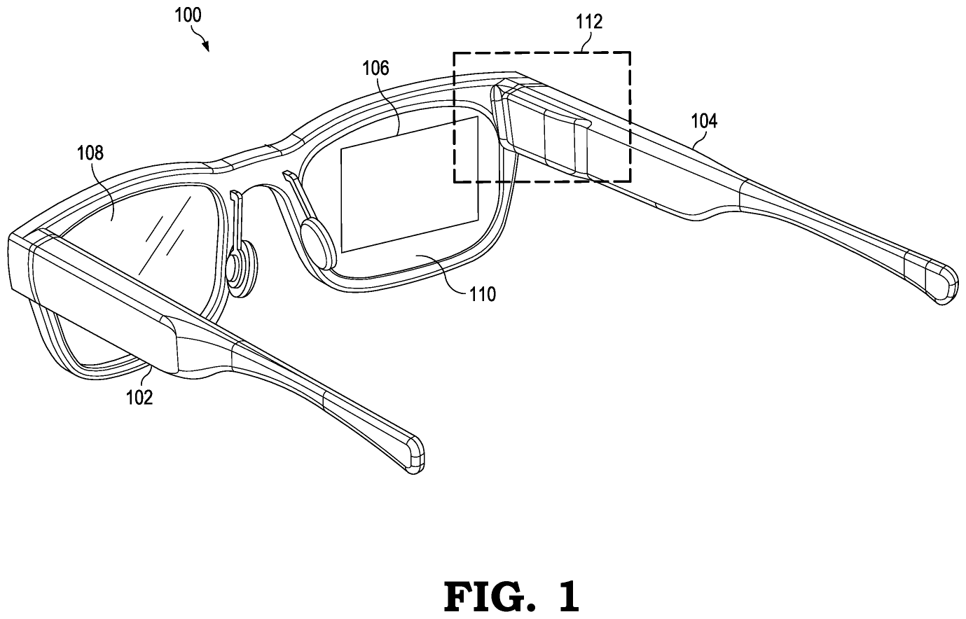

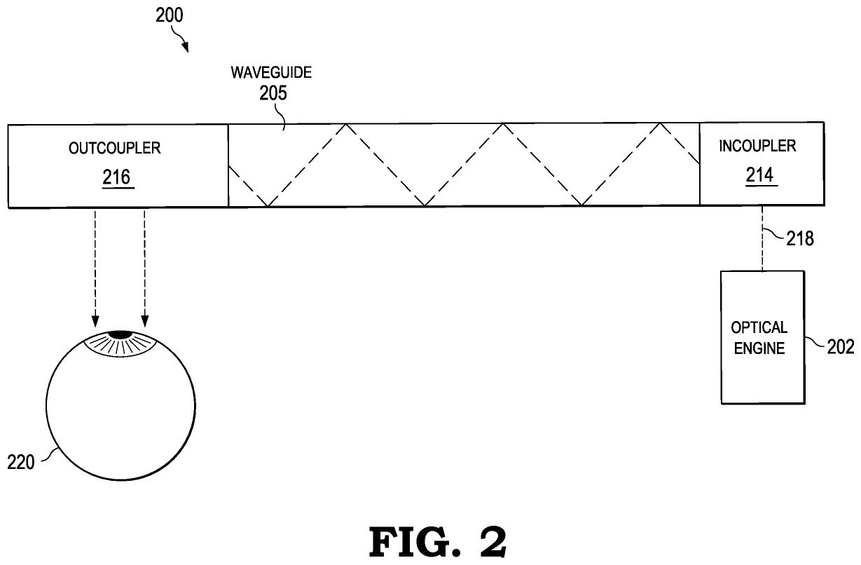

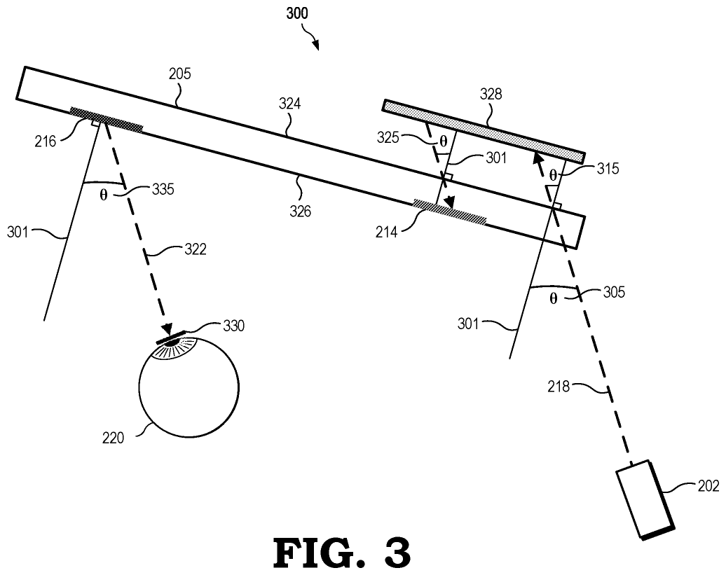

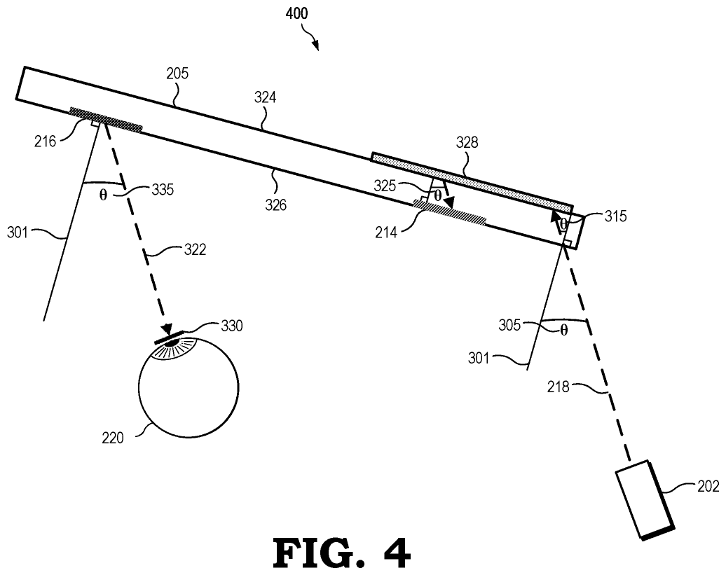

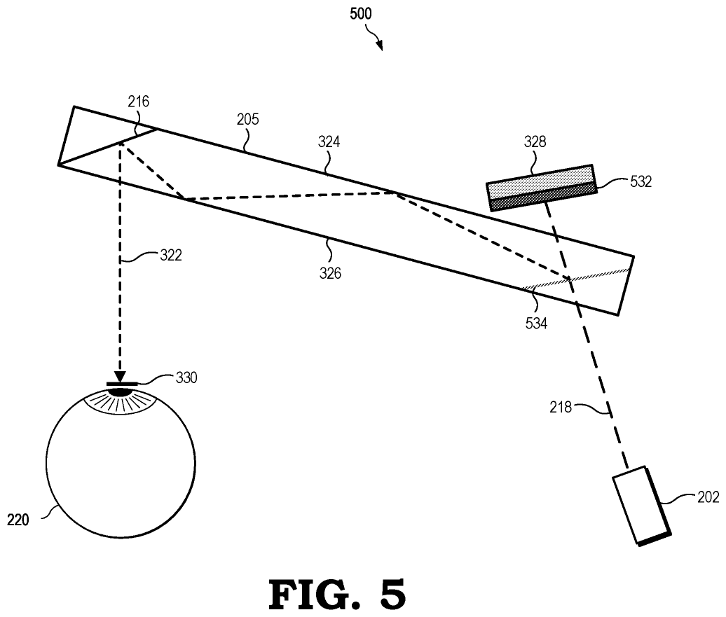

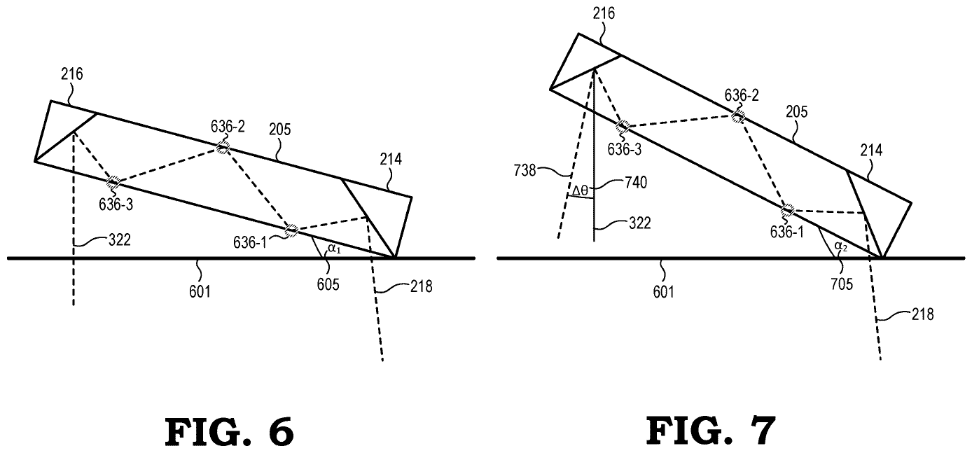

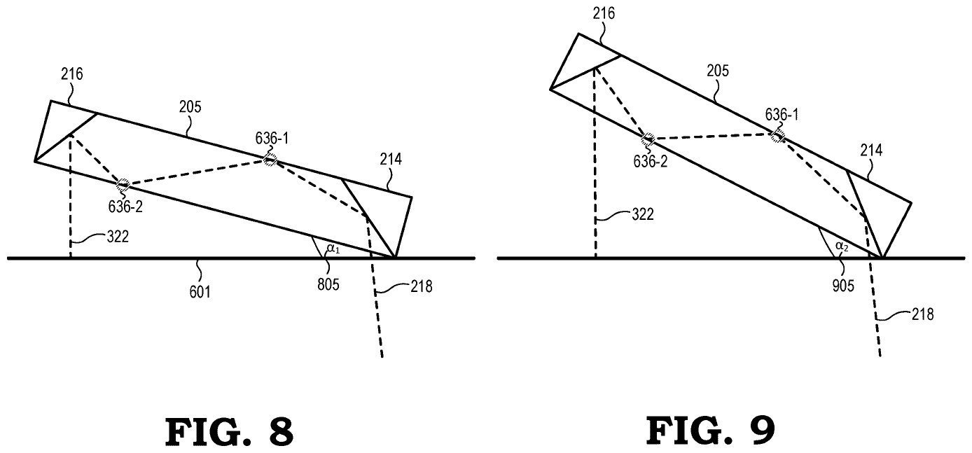

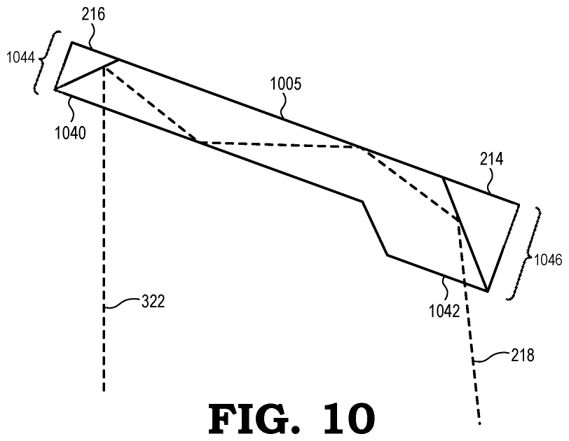

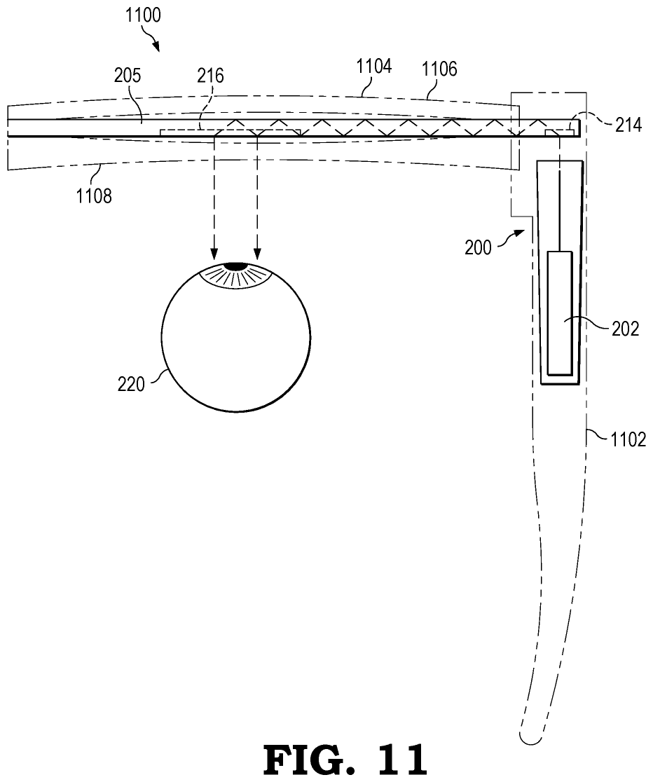

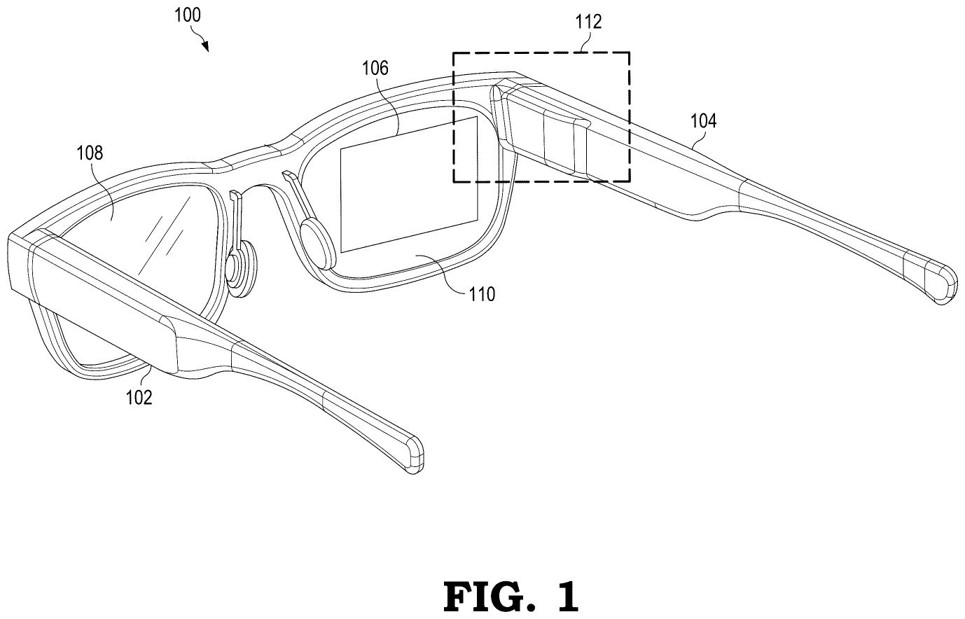

FIG. 1 illustrates an example display system 100 having a support structure 102 that includes an arm 104, which houses a projection system configured to project images toward the eye of a user, such that the user perceives the projected images as being displayed in a field of view (FOV) area 106 of a display at one or both of lens elements 108, 110. In the depicted embodiment, the display system 100 is a head-worn display (HWD) that includes a support structure 102 configured to be worn on the head of a user and has a general shape and appearance of an eyeglasses frame or sunglasses frame. The support structure 102 contains or otherwise includes various components to facilitate the projection of such images toward the eye of the user, such as a projector (e.g., optical engine) and a lightguide. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth interface, a Wi-Fi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1.

One or both of the lens elements 108, 110 are used by the display system 100 to provide an augmented reality (AR) display in which rendered graphical content can be superimposed over or otherwise provided in conjunction with a real-world view as perceived by the user through the lens elements 108, 110. For example, display light used to form a perceptible image or series of images may be projected (e.g., emitted) by a projector of the display system 100 onto the eye of the user via a series of optical elements, such as a lightguide formed at least partially in the corresponding lens element. One or both of the lens elements 108, 110 thus include at least a portion of a lightguide that routes display light received by an incoupler of the lightguide to an outcoupler of the lightguide, which outputs the display light toward an eye of a user of the display system 100. The display light is modulated onto the eye of the user such that the user perceives the display light as an image. In addition, each of the lens elements 108, 110 is sufficiently transparent to allow a user to see through the lens elements to provide an FOV of the user's real-world environment such that the image appears superimposed over at least a portion of the real-world environment.

In some embodiments, the projector is a digital light processing-based projector, a micro-projector, a scanning laser projector, or any combination of a modulative light source such as a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode). The projector is communicatively coupled to the controller and a non-transitory processor-readable storage medium or a memory that stores processor-executable instructions and other data that, when executed by the controller, cause the controller to control the operation of the projector.

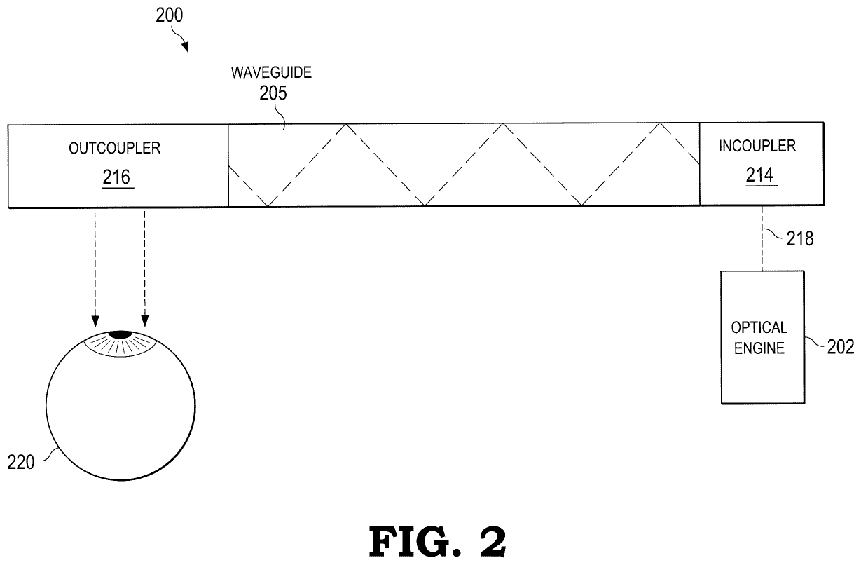

FIG. 2 illustrates a simplified block diagram of a projection system 200 that projects images directly onto the eye of a user via display light. The projection system 200 includes an optical engine 202 and a lightguide 205. The term “lightguide,” as used herein, will be understood to mean a combiner using one or more of total internal reflection (TIR), partial internal reflection (PIR), specialized filters, and/or reflective surfaces, to transfer light from an incoupler (such as the incoupler 214) to an outcoupler (such as the outcoupler 216). In some display applications, the light is a collimated image, and the lightguide transfers and replicates the collimated image to the eye. In some embodiments, the projection system 200 is implemented in a WHD or other display system, such as the display system 100 of FIG. 1.

The optical engine 202 includes one or more display light sources configured to generate and output display light 218 (e.g., visible display light such as red, blue, and green display light and/or non-visible display light such as infrared display light) representing an image. In some embodiments, the optical engine 202 is coupled to a driver or other controller (not shown), which controls the timing of emission of display light from the display light sources of the optical engine 202 in accordance with instructions received by the controller or driver from a computer processor coupled thereto to modulate the display light 218 to be perceived as images when output to the retina of an eye 220 of a user. For example, during the operation of the projection system 200, multiple display light beams having respectively different wavelengths are output by the display light sources of the optical engine 202, then combined via a beam combiner (not shown), before being directed to the eye 220 of the user. The optical engine 202 modulates the respective intensities of the display light beams so that the combined display light reflects a series of pixels of an image, with the particular intensity of each display light beam at any given point in time contributing to the amount of corresponding color content and brightness in the pixel being represented by the combined display light at that time.

Further, the lightguide 205 includes an incoupler 214 and an outcoupler 216, with the outcoupler 216 being optically aligned with an eye 220 of a user in the present example. In some embodiments, the incoupler 214 has a substantially rectangular, circular, or elliptical profile and is configured to receive the display light 218 and direct the display light 218 into the lightguide 205. To this end, the incoupler 214 includes one or more reflective facets configured to reflect and direct display light 218 into the lightguide 205. Such reflective facets, for example, include one or more structures disposed within the lightguide 205 that each has one or more reflective surfaces, reflective coatings, mirrors (e.g., di-electric mirrors, metallic mirrors, Bragg facets), mirror coatings, or any combination thereof. According to embodiments, in response to receiving display light 218, the incoupler 214 is configured to provide the display light 218 to lightguide 205 such that the display light 218 propagates through lightguide 205 via TIR until it is received by the outcoupler 216. As an example, the incoupler 214 provides display light 218 to lightguide 205 such that display light 218 performs one or more bounces (e.g., reflects off a surface of lightguide 205) before being received by the outcoupler 216. After receiving display light 218, the outcoupler 216 is configured to direct display light 218 out of the lightguide 205 and toward the eye 220 of the user. For example, the outcoupler 216 includes one or more reflective facets configured to reflect and direct display light 218 out of the lightguide 205 and toward the eye 220 of a user. Such reflective facets, for example, include one or more structures disposed within the lightguide 205 that each has one or more reflective surfaces, reflective coatings, mirrors (e.g., di-electric mirrors, metallic mirrors, Bragg facets), mirror coatings, or any combination thereof. In an embodiment, the display light 218 directed out of the lightguide 205 by the outcoupler 216 forms an exit pupil at a position near the eye 220 of the user. Such an exit pupil, for example, includes the image of the display light 218 emitted by optical engine 202 and refers to the location along the optical path where two or more beams of the display light 218 intersect. As an example, the width (e.g., smallest dimension) of a given exit pupil approximately corresponds to the diameter of the display light 218 corresponding to that exit pupil. Accordingly, the exit pupil can be considered a “virtual aperture”.

Although not shown in the example of FIG. 2, in some embodiments additional optical components are included in any of the optical paths between the optical engine 202 and the incoupler 214, between the incoupler 214 and the outcoupler 216, and/or between the outcoupler 216 and the eye 220 (e.g., in order to shape the display light for viewing by the eye 220 of the user). In some embodiments, a prism is used to steer light into the incoupler 214 so that light is coupled into incoupler 214 at the appropriate angle to encourage the propagation of the light in lightguide 205 by TIR. Also, in some embodiments, an exit pupil expander (EPE), such as a fold grating, is arranged in an intermediate stage between incoupler 214 and outcoupler 216 to receive light that is coupled into lightguide 205 by the incoupler 214, expand the light, and redirect the light towards the outcoupler 216, where the outcoupler 216 then couples the display light out of lightguide 205 (e.g., toward the eye 220 of the user).

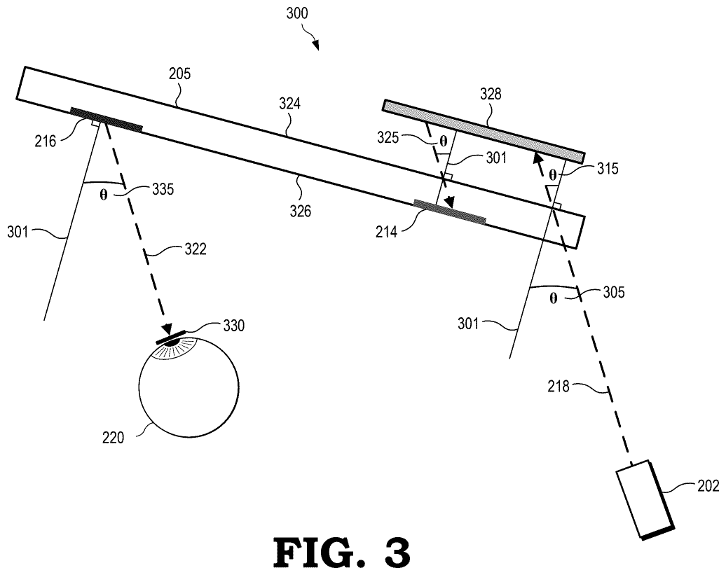

Referring now to FIG. 3, a projection system 300 including one or more reflective facets configured to provide light to the eye of a user is presented. According to embodiments, projection system 300 is similar to or the same as projection system 200 and, in some embodiments, is implemented in a WHD or other display system, such as the display system 100 of FIG. 1. Within projection system 300, the lightguide 205 has a first surface 324 (e.g., world-facing surface) facing away from the eye 220 of a user and a second surface 326 (e.g., user-facing surface) that faces the eye 220 of the user. In embodiments, projection system 300 includes an optical engine 202 emitting display light 218 representing an image toward the second surface 326 of the lightguide 205. For example, the optical engine 202 is configured to emit display light 218 such that display light 218 is received at a first angle 305 at the second surface 326 (e.g., is incident on the second surface 326 at the first angle 305). The first angle 305, for example, represents the angle between display light 218 and an axis 301 perpendicular to the first and second surfaces 324, 326 of the lightguide 205. According to embodiments, after being received at the second surface 326 of the lightguide 205, the display light 218 is configured to pass through the lightguide 205 and be received by a retroreflector 328. For example, the display light 218 is configured to be received by (e.g., be incident upon) the retroreflector 328 at a second angle 315 equal to the first angle 305 (e.g., the angle at which the display light 218 was incident upon the second surface 326 of the lightguide 205).

The retroreflector 328 includes, for example, a corner cube retroflector, glass bead retroreflector, full cube retroreflector, or the like configured to receive a beam of light and reflect the light back along an incident path, irrespective of the angle of incidence of the beam of light. To this end, the retroreflector 328 includes one or more structures (e.g., prisms, reflective surfaces, reflective facets, mirror coatings) configured to reflect light at an angle toward the source of the light at the same angle. In embodiments, the retroreflector 328 is disposed a distance away from the first surface 324 of the lightguide 205 and disposed effectively parallel to the first surface 324 of the lightguide 205 (e.g., disposed such that light reflecting between the retroreflector 328 and the lightguide 205 behaves as if the retroreflector 328 and the lightguide 205 are parallel). As an example, the retroreflector 328 is disposed effectively parallel to the first surface 324 of the lightguide 205 such that the retroreflector 328 is configured to receive display light 218 from optical engine 202 and reflect display light 218 toward the incoupler 214 of the lightguide 205. According to embodiments, within projection system 300, retroreflector 328 is configured to receive the display light 218 at an angle (e.g., second angle 315) and then reflect display light 218 toward the incoupler 214 of the lightguide 205 at the same angle (e.g., third angle 325). That is to say, retroreflector 328 is configured to reflect display light 218 such that display light 218 is incident upon the incoupler 214 at an angle (e.g., third angle 325) equal to the angle (e.g., second angle 315) upon which display light 218 was incident upon the retroreflector 328. For example, in the example embodiment of FIG. 3, the retroreflector 328 is configured to reflect the display light 218 toward the incoupler 214 at the third angle 325 which is equal to the second angle 315 and the first angle 305.

In response to receiving display light 218, the incoupler 214 is configured to reflect display light 218 such that display light 218 propagates through lightguide 205 via TIR before being received at the outcoupler 216 of the lightguide 205. For example, incoupler 214 includes one or more reflective facets (e.g., one or more structures disposed within a lightguide having one or more reflective surfaces, reflective coatings, mirror coatings, or any combination thereof) configured to reflect display light 218 such that display light 218 propagates through the lightguide 205 via TIR. In response to receiving the display light 218, the outcoupler 216 is configured to direct the display light 218 out of the lightguide 205 and toward the eye 220 of the user as output light 322. As an example, the outcoupler 216 includes one or more reflective facets (e.g., one or more structures disposed within a lightguide having one or more reflective surfaces, reflective coatings, mirror coatings, or any combination thereof) configured to reflect display light 218 such that display light 218 exits the lightguide 205 and is directed toward the eye 220 of a user as output light 322. As the output light 322 travels to the eye 220 of the user, one or more beams of the output light 322 overlap to form exit pupil 330 that includes the image represented by display light 218 emitted by the optical engine 202. According to embodiments, the output light 322 is configured to form exit pupil 330 near the eye 220 of the user such that the image of the exit pupil 330 is visible to the user.

According to some embodiments, the outcoupler 216 is configured to direct display light 218 out of the lightguide 205 (e.g., output light 322) at an angle (e.g., fourth angle 335) equal to the angle (e.g., third angle 325) upon which the display light 218 was incident upon the incoupler 214. Such a fourth angle 335, for example, represents the angle between the output light 322 and the axis 301 perpendicular to the surfaces 324, 326 of the lightguide. For example, referring to the example embodiment presented in FIG. 3, the outcoupler 216 directs output light 322 at a fourth angle 335 equal to the third angle 325, second angle 315, and first angle 305. In this way, in some embodiments, output light 322 is parallel to the display light 218 emitted from the optical engine 202.

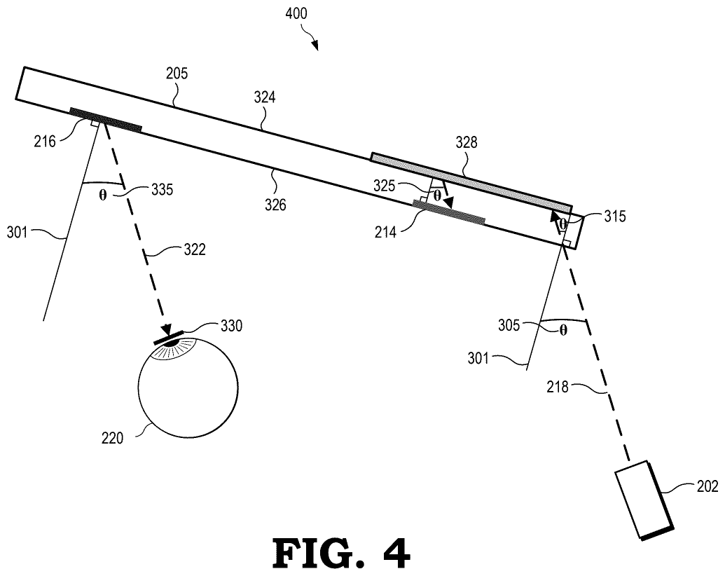

Referring now to FIG. 4, a projection system 400 including a retroflector and one or more reflective facets configured to provide light to the eye of a user is presented. According to embodiments, projection system 400 is similar to or the same as projection systems 200, 300 and, in some embodiments, is implemented in a WHD or other display system, such as the display system 100 of FIG. 1. According to embodiments, projection system 400 is configured to direct display light 218 emitted from an optical engine 202 to the eye 220 of a user as output light 322 similarly or the same as projection system 300 discussed above with reference to FIG. 3. For example, projection system 400 is configured to direct display light 218 emitted from the optical engine 202 at a first angle (e.g., first angle 305) through lightguide 205 such that the outcoupler 216 of the lightguide 205 directs output light 322 out of the lightguide 205 at a second angle (e.g., fourth angle 335) equal to the first angle (e.g., so that the display light 218 emitted from the optical engine and output light 322 are parallel).

According to embodiments, within projection system 400, the retroreflector 328 is disposed on the first surface 324 of the lightguide 205. The retroreflector 328 is configured to receive the display light 218 after the display light 218 passes through the lightguide 205. In some embodiments, the retroreflector 328 receives the display light 218 at an angle (e.g., second angle 315) equal to the angle (e.g., first angle 305) at which the display light 218 was incident upon the second surface 326 of the lightguide 205. That is to say, the display light 218 is incident upon the retroreflector 328 at an angle (e.g., second angle 315) equal to the angle (e.g., first angle) upon which the display light 218 was incident upon the lightguide 205. In response to receiving the display light 218, the retroreflector 328 is configured to reflect the display light 218 toward the incoupler 214 of the lightguide 205. As an example, the retroreflector 328 is configured to reflect the display light 218 toward the incoupler 214 at an angle (e.g., third angle 325) equal to the angle (e.g., second angle 315) that the retroreflector 328 received the display light 218. The incoupler 214 then directs the display light 218 into the lightguide 205 such that the display light 218 propagates through the lightguide 205 via TIR and is received at the outcoupler 216. The outcoupler 216 then directs the display light 218 out of the lightguide 205 as output light 322 at an angle (e.g., fourth angle 335) equal to the angle (e.g., first angle 305) at which the display light 218 was emitted from the optical engine 202 (e.g., the angle at which the emitted display light 218 was incident upon the lightguide 205).

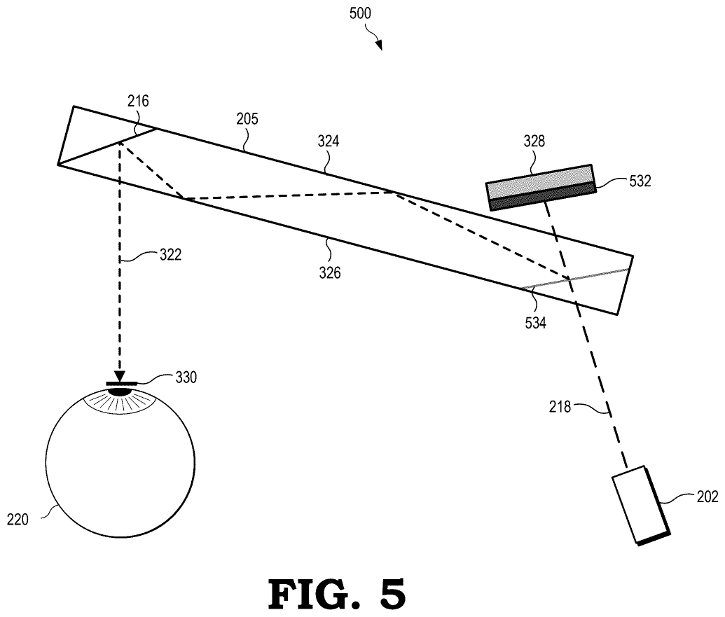

Referring now to FIG. 5, a projection system 500 including one or more reflective facets configured to provide light to the eye of a user is presented.

According to embodiments, projection system 400 is similar to or the same as projection systems 200, 300 and, in some embodiments, is implemented in a WHD or other display system, such as the display system 100 of FIG. 1. Within projection system 500, the optical engine 202 emits display light 218 representing an image toward the lightguide 205. In embodiments, the display light 218 is configured to pass through at least a portion of the lightguide 205 before being received at an incoupler (e.g., incoupler 214) that includes a polarizing beam splitter (PBS) 534. The PBS 534, for example, includes a cube PBS, plate PBS, or the like configured to split an unpolarized incident beam (e.g., beam of light) into a first beam polarized in a first linear direction and a second beam polarized in a second linear direction. To this end, in embodiments, PBS 534 is configured to transmit light polarized in a first linear direction (e.g., P-polarization, S-polarization) and reflect light polarized in a second linear direction (e.g., P-polarization, S-polarization) that is different from the first linear direction. In response to receiving display light 218, PBS 534 is configured to transmit at least a portion of display light 218 polarized in a first linear direction (S-polarization, P-polarization) out of the lightguide 205 and toward a retroreflector 328 disposed near the first surface 324 of the lightguide 205.

According to some embodiments, projection system 500 includes a quarter waveplate 532 disposed between the lightguide 205 and the retroreflector 328. Such a quarter waveplate 532, for example, is configured to polarize light in a circular direction (e.g., right-hand direction, left-hand direction). For example, the quarter waveplate 532 includes a quarter waveplate film configured to polarize light in a circular direction. In embodiments, the quarter waveplate 532 is configured to receive the portion of display light 218 polarized in a first linear direction transmitted from PBS 534. In response to receiving the portion of display light 218 polarized in the first linear direction, the quarter waveplate 532 polarizes the portion of display light 218 in a circular direction (e.g., right-hand direction, left-hand direction) and provides the circularly polarized display light to retroreflector 328. Retroreflector 328 then reflects the circularly polarized display light back toward the PBS 534 and the circularly polarized display light again passes through the quarter waveplate 532. The quarter waveplate 532 then circularly polarizes the circularly polarized display light to produce display light polarized in a second linear direction (e.g., S-polarization, P-polarization) that is perpendicular to the first linear direction. For example, because the circularly polarized display light was circularly polarized before being reflected by retroreflector 328, the quarter waveplate 532 again circularly polarizes the circularly polarized light to produce display light polarized in a second linear direction that is perpendicular to the first linear direction of the polarized display light transmitted by PBS 534. After circularly polarizing the light reflected off retroreflector 328 to produce the display light polarized in a second linear direction, the quarter waveplate 532 provides the display light polarized in the second linear direction to PBS 534.

In response to receiving the display light polarized in the second linear direction from quarter waveplate 532, the PBS 534 is configured to reflect the display light polarized in the second linear direction into the lightguide 205 such that the display light polarized in the second linear direction propagates through the lightguide 205 via TIR. According to embodiments, the display light propagates through the lightguide 205 until the display light is received by the outcoupler 216. The outcoupler 216 is then configured to direct the display light polarized in the second linear direction out of the lightguide 205 and toward the eye 220 of the user as output light 322. As the output light 322 travels to the eye 220 of the user, one or more beams of the output light 322 overlap to form exit pupil 330 that includes the image represented by the display light 218 emitted from the optical engine 202. As an example, the output light 322 forms the exit pupil 330 near the eye 220 of the user such that the user is able to perceive the image in the exit pupil 330.

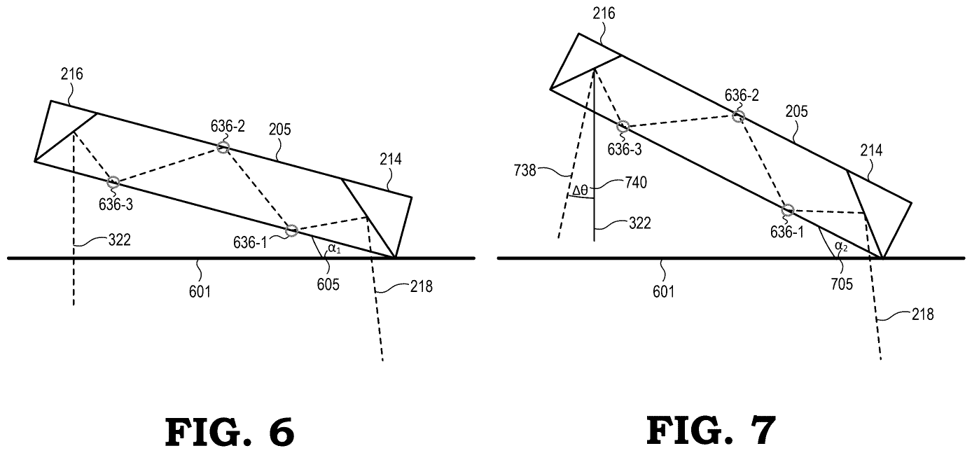

Referring now to FIGS. 6 and 7, FIGS. 6 and 7 together present a lightguide 205 as the lightguide 205 changes positions. For example, referring to FIG. 6, the lightguide 205 is at a first position such that the lightguide 205 is at a first angle a1 605 relative to a horizontal axis 601 (e.g., a horizon). At the first position, the lightguide 205 receives display light 218 (e.g., as emitted from an optical engine 202) at an incoupler 214. The incoupler 214 includes one or more reflective facets (e.g., one or more structures disposed within a lightguide having one or more reflective surfaces, reflective coatings, mirrors, mirror coatings, or any combination thereof) configured to reflect the display light 218 such that the display light propagates through the lightguide 205. For example, the incoupler 214 reflects the display light 218 such that the display light 218 propagates through the lightguide 205 via TIR until the display light 218 is received at the outcoupler 216 of the lightguide 205. As the display light 218 propagates through the lightguide 205, the display light 218 performs an odd number of bounces 636 before being received by the outcoupler 216. That is to say, the display light 218 reflects off the surfaces of the lightguide 205 an odd number of times before being received by the outcoupler 216. Though the example embodiments presented in FIGS. 6 and 7 show the display light 218 performing three bounces (636-1, 636-2, 636-3) as the display light 218 propagates through the lightguide 205, in other embodiments, the display light 218 can perform any odd number of bounces 636 before being received by the outcoupler 216. After the display light 218 is received at the outcoupler 216, the outcoupler 216 directs the display light 218 out of the lightguide 205 as output light 322. For example, the outcoupler 216 includes one or more reflective facets (e.g., one or more structures disposed within a lightguide having one or more reflective surfaces, reflective coatings, mirrors, mirror coatings, or any combination thereof) configured to reflect the display light 218 out of the lightguide 205 and toward the eye of a user.

Referring now to FIG. 7, lightguide 205 is at a second position such that the lightguide 205 is at a second angle α₂ 705 relative to a horizontal axis 601 (e.g., a horizon) that is different from the first angle α₁ 605. At the second position, the lightguide 205 receives display light 218 at the incoupler 214. The incoupler 214 then reflects the display light 218 such that the display light 218 propagates through the lightguide 205 via TIR with an odd number of bounces (e.g., 636-1, 636-2, 636-3) until the display light 218 is received at the outcoupler 216 of the lightguide 205. In response to receiving the display light 218, the outcoupler 216 directs the display light 218 out of the lightguide 205 as output light 738. However, because the display light 218 propagates through the light guide 205 with an odd number of bounces 636, the angle at which the outcoupler 216 directs output light 738 when the lightguide is in the second position is different from the angle at which the outcoupler 216 directs output light 322 when the lightguide is in the first position. That is to say, there is a difference in the angle (e.g., Δθ 740) between the light (e.g., output light 322) output by outcoupler 216 when the lightguide is in the first position (e.g., angle α₁ 605) and the light (e.g., output light 738) output by the outcoupler 216 when the lightguide is in the second position (e.g., angle α₂ 705). As such, when the display light 218 propagates through the lightguide 205 with an odd number of bounces 636, the angle at which the outcoupler 216 outputs light changes as the lightguide 205 changes position (e.g., as the lightguide 205 rotates or moves). However, changing the angle at which light exits the lightguide 205 (e.g., the angle at which outcoupler 216 outputs light) increases the likelihood that an exit pupil 330 formed by the exiting light forms at a position away from the eye 220 of the user such that the image in the exit pupil 330 is not visible to the user, negatively impacting user experience.

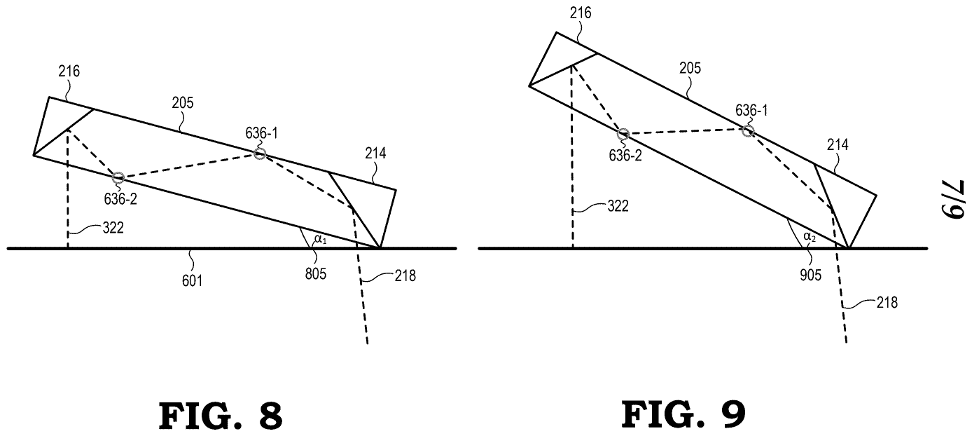

To this end, in some embodiments, lightguides 205 used in one or more projection systems (e.g., projection systems 200, 300, 400, 500) are configured such that display light 218 propagates through the lightguide 205 via TIR with an even number of bounces 636. To this end, FIGS. 8 and 9 together present a lightguide 205 configured such that display light 218 propagates through the lightguide 205 via TIR with an even number of bounces 636 as the lightguide 205 rotates. As an example, referring now to FIG. 8, the lightguide 205 is at a first position such that the lightguide 205 is at a first angle α₁ 805 relative to a horizontal axis 601 (e.g., a horizon). At the first position, the lightguide 205 receives display light 218 (e.g., as emitted from an optical engine 202) at an incoupler 214. The incoupler 214 then reflects the display light 218 such that the display light 218 propagates through the lightguide 205 via TIR until the display light 218 is received at the outcoupler 216 of the lightguide 205. As an example, the incoupler 214 reflects the display light 218 such that the display light 218 performs an even number of bounces (e.g., 636-1, 636-2) within the lightguide 205 before being received by the outcoupler 216. Though the example embodiments presented in FIGS. 8 and 9 show the display light 218 performing two bounces (636-1, 636-2) as the display light 218 propagates through the lightguide 205, in other embodiments, the display light 218 can perform any even number of bounces 636 before being received by the outcoupler 216. After the display light 218 is received at the outcoupler 216, the outcoupler 216 directs the display light 218 out of the lightguide 205 as output light 322.

Referring now to FIG. 9, lightguide 205 is at a second position such that the lightguide 205 is at a second angle α₂ 905 relative to a horizontal axis 601 (e.g., a horizon) that is different from the first angle α₁ 805. At the second position, the lightguide 205 receives display light 218 at the incoupler 214. The incoupler 214 then reflects the display light 218 such that the display light 218 propagates through the lightguide 205 via TIR with an even number of bounces (e.g., 636-1, 636-2) until the display light 218 is received at the outcoupler 216 of the lightguide 205. In response to receiving the display light 218, the outcoupler 216 directs the display light 218 out of the lightguide 205 as output light 322. Because the display light 218 performs an even number of bounces 636 while propagating through the lightguide 205 before being received at the outcoupler 216, the angle of the light (e.g., output light 322) directed out of the lightguide 205 by outcoupler 216 is the same when the lightguide 205 is at the first position (e.g., angle α₁ 805) and when the lightguide 205 is at the second position (e.g., angle α2 905). In this way, as the lightguide 205 changes positions (e.g., as the lightguide 205 moves or rotates) the angle of the light output by outcoupler 216 is maintained. Because the angle is maintained, the likelihood that an exit pupil 330 is formed at a position away from the eye 220 of the user such that the image in the exit pupil 330 is not visible to the user is reduced, improving user experience.

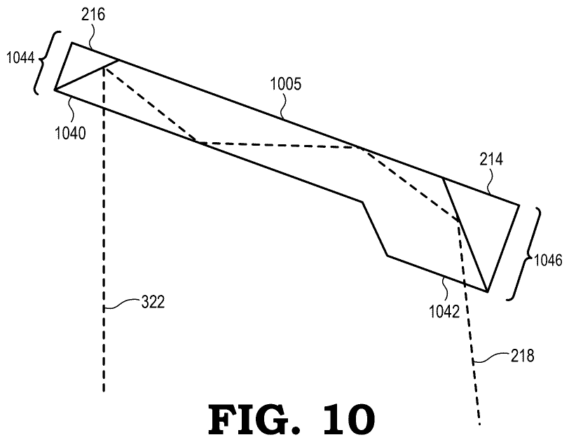

Referring now to FIG. 10, an example lightguide 1005 is presented. In embodiments, example lightguide 1005 is similar to or the same as lightguide 205 and is implemented in one or more projection systems 200, 300, 400, 500. According to some embodiments, example lightguide 1005 has a first end 1040 and a second, opposite end 1042. In some embodiments, the first end 1040 of the lightguide 205 has a first thickness 1044 and the second end 1042 has a second thickness 1046 that is different from the first thickness 1044. For example, the second end 1042 has a thickness 1046 that is greater than the thickness 1044 of the first end 1040. An incoupler 214 is disposed at the second end 1042 of the lightguide 205 and is configured to receive display light 218 (e.g., as emitted by an optical engine 202). In response to receiving the display light 218, the incoupler 214 reflects the display light 218 such that the display light 218 propagates through the lightguide 205 via TIR and performs an even number of bounces. The display light 218 is then received at an outcoupler 216 disposed at the first end of the lightguide 205. In response to receiving the display light 218, the outcoupler 216 reflects the display light 218 out of the lightguide 205 as output light 322.

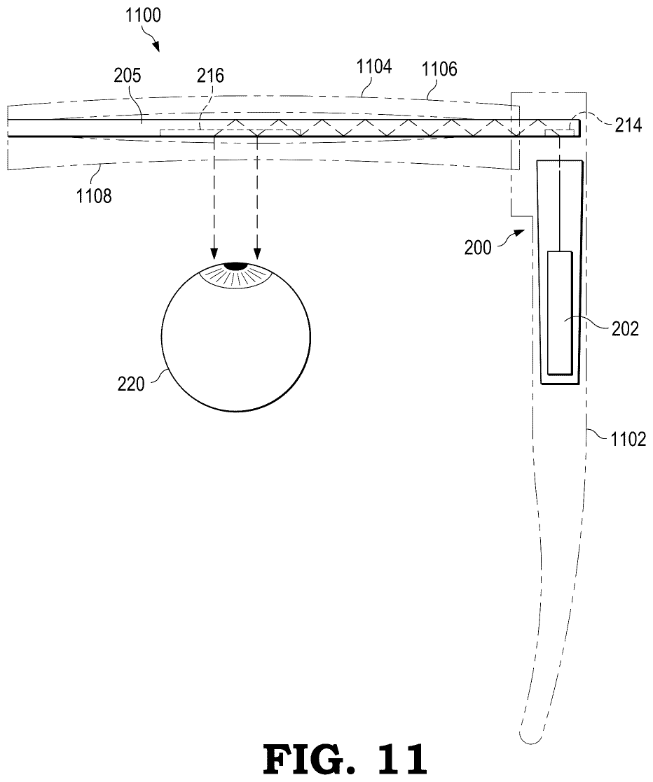

FIG. 11 illustrates a portion of an eyewear display 1100 that includes the projection system 200 of FIG. 2, the projection system 300 of FIG. 3, the projection system 400 of FIG. 4, the projection system 500 of FIG. 5, or any combination thereof. In some embodiments, the eyewear display 1100 represents the display system 100 of FIG. 1. The optical engine 202, the incoupler 214, the outcoupler 216, and a portion of the lightguide 205, 1005 are included in an arm 1102 of the eyewear display 1100, in the present example.

The eyewear display 1100 includes an optical combiner lens 1104, which includes a first lens 1106, a second lens 1108, and the lightguide 205, with the lightguide 205 disposed between the first lens 1106 and the second lens 1108. Light exiting through the outcoupler 216 travels through the second lens 1108 (which corresponds to, for example, the lens element 110 of the display system 100). In use, the light exiting second lens 1108 enters the pupil of an eye 220 of a user wearing the eyewear display 1100, causing the user to perceive a displayed image carried by the display light output by the optical engine 202. The optical combiner lens 1104 is substantially transparent, such that light from real-world scenes corresponding to the environment around the eyewear display 1100 passes through the first lens 1106, the second lens 1108, and the lightguide 205 to the eye 220 of the user. In this way, images or other graphical content output by the projection systems 200, 300, 400, 500 are combined (e.g., overlayed) with real-world images of the user's environment when projected onto the eye 220 of the user to provide an AR experience to the user.

Although not shown in the depicted example, in some embodiments additional optical elements are included in any of the optical paths between the optical engine 202 and the incoupler 214, in between the incoupler 214 and the outcoupler 216, and/or in between the outcoupler 216 and the eye 220 of the user (e.g., in order to shape the display light for viewing by the eye 220 of the user). As an example, retroreflector 328 is used to reflect light into the incoupler 214 so that light is coupled into incoupler 214 at the appropriate angle to encourage propagation of the light in lightguide 205 by TIR. Also, in some embodiments, an exit pupil expander, such as a fold grating, is arranged in an intermediate stage between incoupler 214 and outcoupler 216 to receive light that is coupled into lightguide 205 by the incoupler 214, expand the light, and redirect the light towards the outcoupler 216, where the outcoupler 216 then couples the display light out of lightguide 205 (e.g., toward the eye 220 of the user).

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or another instruction format that is interpreted or otherwise executable by one or more processors.

A computer-readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A head-worn display (HWD), comprising:
an optical engine configured to emit display light; and
a lightguide including an incoupler and an outcoupler, wherein:
the incoupler is configured to reflect the display light such that the display light propagates through the lightguide by performing an even number of bounces before being received by the outcoupler.

2. The HWD of claim 1, wherein the outcoupler is configured to direct the display light out of the lightguide at a first angle when the lightguide is at the first angle.

3. The HWD of claim 2, wherein the outcoupler is configured to direct the display light out of the lightguide at the first angle when the lightguide is at a second angle different from the first angle.

4. The HWD of claim 1, wherein the incoupler comprises one or more reflective facets configured to reflect the display light into the lightguide.

5. The HWD of claim 1, further comprising:
a retroreflector configured to reflect the display light emitted from the optical engine toward the incoupler.

6. The HWD of claim 5, further comprising:
a quarter waveplate disposed between the lightguide and the retroreflector.

7. The HWD of claim 6, wherein the incoupler comprises a polarizing beam splitter (PBS) configured to provide display light polarized in a first linear direction to the quarter waveplate.

8. The HWD of claim 7, wherein the quarter waveplate is configured to polarize the display light reflected by the retroreflector to produce display light polarized in a second linear direction perpendicular to the first linear direction.

9. The HWD of claim 8, wherein the PBS is configured to reflect the display light polarized in the second linear direction into the lightguide.

10. The HWD of claim 1, wherein the lightguide has a first thickness at a first end of the lightguide and a second thickness at a second, opposite end of the lightguide, wherein the first thickness is different from the second thickness.

11. The HWD of claim 1, wherein the outcoupler includes one or more reflective facets configured to reflect the display light out of the lightguide 205.

12. (canceled)

13. A lightguide for a head-worn display (HWD), comprising:
an outcoupler including one or more reflective facets; and
an incoupler including one or more reflective facets configured to reflect display light such that the display light propagates through the lightguide by performing an even number of bounces before being received by the outcoupler.

14. The lightguide of claim 13, wherein the outcoupler is configured to direct the display light out of the lightguide at a first angle when the lightguide is at the first angle.

15. The lightguide of claim 14, wherein the outcoupler is configured to direct the display light out of the lightguide at the first angle when the lightguide is at a second angle different from the first angle.

16. The lightguide of claim 13, further comprising:
a retroreflector disposed on a surface of the lightguide and configured to reflect the display light toward the incoupler.

17. The lightguide of claim 13, further comprising:
a first thickness at a first end of the lightguide; and
a second thickness at a second, opposite end of the lightguide, wherein the first thickness is different from the second thickness.

18. The lightguide of claim 13, wherein the one or more reflective facets of the outcoupler are disposed within the lightguide.

19. The lightguide of claim 13, wherein the one or more reflective facets of the incoupler are disposed within the lightguide.

20. A method, comprising:
reflecting, by an incoupler of a lightguide, display light into the lightguide such that the display light propagates through the lightguide by performing an even number of bounces before being received at an outcoupler of the lightguide; and
directing, by the outcoupler of the lightguide, the display light out of the lightguide at an angle.

21. The method of claim 20, further comprising:
maintaining the angle that the display light is directed out of the lightguide as the lightguide rotates.

22. The method of claim 20, wherein the outcoupler comprises one or more reflective facets configured to reflect the display light out of the lightguide.

23. The method of claim 20, further comprising:
reflecting, by a retroreflector, the display light toward the incoupler of the lightguide.

24. The method of claim 20, further comprising:
providing a portion of the display light polarized in a first linear direction to a quarter waveplate.

25. The method of claim 24, further comprising:
polarizing the portion of the display light polarized in the first linear direction in a circular direction to produce circularly polarized display light;
polarizing the circularly polarized display light to produce display light polarized in a second linear direction perpendicular to the first linear direction; and
wherein reflecting the display light into the lightguide comprises reflecting the display light polarized in the second linear direction into the lightguide.

26. (canceled)

27. (canceled)
